(19) United States
(12) Patent Application Publication
(10) Pub. No.: US 2023/0347563 A1
(43) Pub. Date: Nov. 2, 2023

(54) INJECTION MOLDING MACHINE MONITORING DEVICE

(71) Applicant: SUMITOMO HEAVY INDUSTRIES, LTD., Tokyo (JP)

(72) Inventors: Atsuro TAMURA, Chiba-shi (JP); Koki INOUE, Chiba-shi (JP)

(21) Appl. No.: 18/348,355

(22) Filed: Jul. 7, 2023

Related U.S. Application Data
(63) Continuation of application No. PCT/JP2022/016332, filed on Mar. 30, 2022.

(30) Foreign Application Priority Data
Mar. 31, 2021 (JP) 2021-062430

(51) Int. Cl. B29C 45/76

(52) U.S. Cl. CPC B29C 45/7653; B29C 2945/76083; B29C 2945/7623; B29C 2945/76391; B29C 2945/76481; B29C 2945/76943

(57) ABSTRACT

A monitoring device of an injection molding machine includes: an acquisition unit that acquires, based on a measured value in a depressurizing process from a detection unit provided in a link member of a toggle mechanism, an amount of change generated in the link member; and a determination unit that determines whether or not the amount of change acquired by the acquisition unit exceeds a predetermined threshold.

### CROSS-REFERENCE TO RELATED APPLICATIONS

This is a bypass continuation of International PCT Application No. PCT/JP2022/016332, filed on Mar. 30, 2022, which claims priority to Japanese Patent Application No. 2021-062430, filed on Mar. 31, 2021, which are incorporated by reference herein in their entirety.

### BACKGROUND

### Technical Field

Certain embodiments of the present invention relate to a monitoring device of an injection molding machine.

### Description of Related Art

In a normal injection molding machine, a molding product is molded by filling a mold unit with a molding material. The mold unit includes a stationary mold and a movable mold. The movable mold is attached to a movable platen, and a mold support device is disposed to be movable in a mold opening and closing direction. A toggle mechanism that moves the movable platen in the mold opening and closing direction is constituted by a plurality of link members. As the movable platen moves in the mold opening and closing direction, the plurality of link members also move, and thus a connection portion of the link members wears.

### SUMMARY

According to an embodiment of the present invention, there is provided a monitoring device of an injection molding machine including: an acquisition unit that acquires, based on a measured value in a depressurizing process from a detection unit provided in a link member of a toggle mechanism, an amount of change generated in the link member; and a determination unit that determines whether or not the amount of change acquired by the acquisition unit exceeds a predetermined threshold.

### BRIEF DESCRIPTION OF THE DRAWINGS

FIG. 1 is a view showing a state when mold opening is completed in an injection molding machine according to one embodiment.

FIG. 2 is a view showing a state when mold clamping is performed in the injection molding machine according to the one embodiment.

FIG. 3 is a configuration diagram of a toggle mechanism included in the injection molding machine according to the one embodiment.

FIG. 4 is a diagram showing a configuration example of a control device according to the one embodiment.

FIG. 5 is a diagram showing forces generated in the toggle mechanism in a depressurizing process according to the one embodiment.

FIG. 6 is a perspective view showing a shape of a second link according to the one embodiment.

FIG. 7 is a front view showing the shape of the second link according to the one embodiment.

FIG. 8 is a diagram illustrating a change in the amount of strain acquired by an acquisition unit in the depressurizing process of the one embodiment.

FIG. 9 is a flowchart showing a procedure of a process of determining whether or not wear has occurred via the control device according to the one embodiment.

FIG. 10 is a diagram illustrating a change in an acceleration acquired by the acquisition unit in the depressurizing process of the one embodiment.

FIG. 11 is a flowchart showing a procedure of a process of determining whether or not wear has occurred via the control device according to the one embodiment.

### DETAILED DESCRIPTION

In a technique in the related art, wear is measured based on the amount of displacement between a position of a member in an initial state before the wear and a position of the member at the time of mold clamping.

However, in recent years, there has been a demand for measuring wear of the above-described link member in a simple manner.

It is desirable to provide a technique for easily measuring wear by performing measurement based on the amount of change generated in a link member at the time of depressurizing in which a mold clamping force decreases.

Hereinafter, embodiments of the present invention will be described with reference to the drawings. In each drawing, the same or corresponding reference numerals will be assigned to the same or corresponding configurations, and description thereof will be omitted.

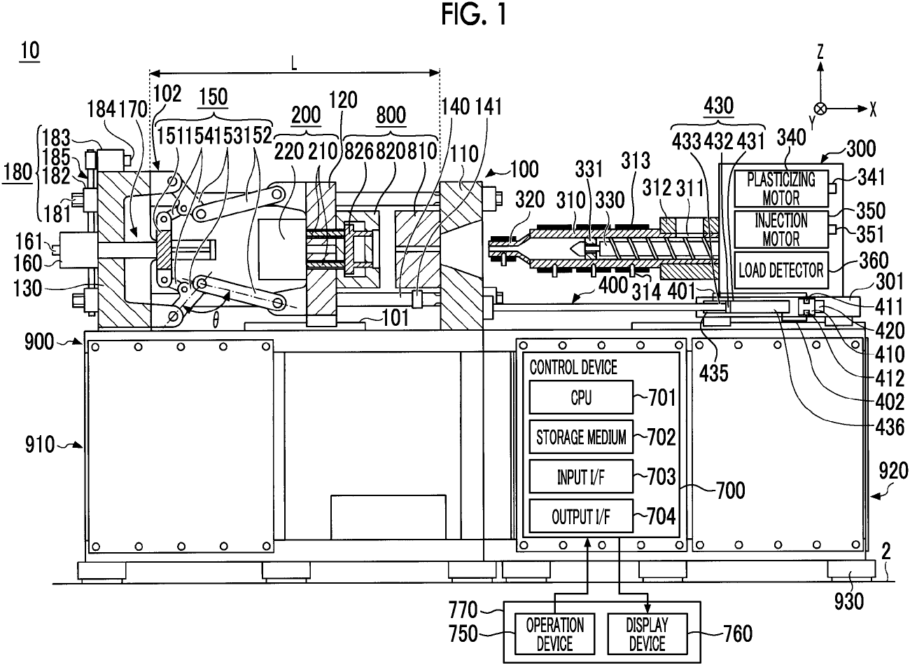

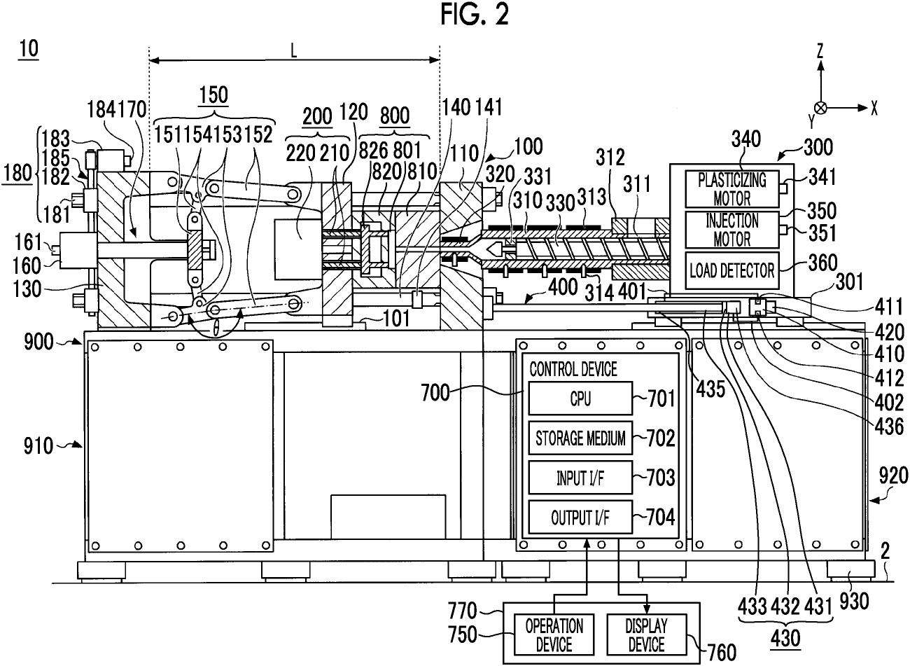

FIG. 1 is a view showing a state when mold opening is completed in an injection molding machine according to one embodiment. FIG. 2 is a view showing a state when mold clamping is performed in the injection molding machine according to the one embodiment. In the present specification, an X-axis direction, a Y-axis direction, and a Z-axis direction are perpendicular to each other. The X-axis direction and the Y-axis direction represent a horizontal direction, and the Z-axis direction represents a vertical direction. In a case where a mold clamping unit 100 is of a horizontal type, the X-axis direction represents a mold opening and closing direction, and the Y-axis direction represents a width direction of an injection molding machine 10. A negative side in the Y-axis direction will be referred to as an operation side, and a positive side in the Y-axis direction will be referred to as a counter operation side.

As shown in FIGS. 1 and 2, the injection molding machine 10 includes the mold clamping unit 100 that opens and closes a mold unit 800, an ejector unit 200 that ejects a molding product molded by the mold unit 800, an injection unit 300 that injects a molding material into the mold unit 800, a moving unit 400 that causes the injection unit 300 to advance and retreat with respect to the mold unit 800, a control device 700 that controls each component of the injection molding machine 10, and a frame 900 that supports each component of the injection molding machine 10. The frame 900 includes a mold clamping unit frame 910 that supports the mold clamping unit 100, and an injection unit frame 920 that supports the injection unit 300. The mold clamping unit frame 910 and the injection unit frame 920 are respectively installed on a floor 2 via a leveling adjuster 930. The control device 700 is disposed in an internal space of the injection unit frame 920. Hereinafter, each component of the injection molding machine 10 will be described.

### Mold Clamping Unit

In describing the mold clamping unit 100, a moving direction of a movable platen 120 during mold closing (for example, a positive direction of an X-axis) will be defined as forward, and a moving direction of the movable platen 120 during mold opening (for example, a negative direction of the X-axis) will be defined as rearward.

The mold clamping unit 100 performs mold closing, pressurizing, mold clamping, depressurizing, and mold opening of the mold unit 800. The mold unit 800 includes a stationary mold 810 and a movable mold 820.

For example, the mold clamping unit 100 is of a horizontal type, and the mold opening and closing direction is a horizontal direction. The mold clamping unit 100 includes a stationary platen 110 to which the stationary mold 810 is attached, the movable platen 120 to which the movable mold 820 is attached, and a moving mechanism 102 that moves the movable platen 120 in the mold opening and closing direction with respect to the stationary platen 110.

The stationary platen 110 is fixed to the mold clamping unit frame 910. The stationary mold 810 is attached to a surface of the stationary platen 110 facing the movable platen 120.

The movable platen 120 is disposed to be movable in the mold opening and closing direction with respect to the mold clamping unit frame 910. A guide 101 that guides the movable platen 120 is laid on the mold clamping unit frame 910. The movable mold 820 is attached to a surface of the movable platen 120 facing the stationary platen 110.

The moving mechanism 102 causes the movable platen 120 to advance and retreat with respect to the stationary platen 110 such that mold closing, pressurizing, mold clamping, depressurizing, and mold opening of the mold unit 800 are performed. The moving mechanism 102 includes a toggle support 130 disposed at an interval from the stationary platen 110, a tie bar 140 that connects the stationary platen 110 and the toggle support 130 to each other, a toggle mechanism 150 that moves the movable platen 120 in the mold opening and closing direction with respect to the toggle support 130, a mold clamping motor 160 that operates the toggle mechanism 150, a motion conversion mechanism 170 that converts a rotary motion into a linear motion of the mold clamping motor 160, and a mold space adjustment mechanism 180 that adjusts an interval between the stationary platen 110 and the toggle support 130.

The toggle support 130 is disposed at an interval from the stationary platen 110, and is placed on the mold clamping unit frame 910 to be movable in the mold opening and closing direction. The toggle support 130 may be disposed to be movable along a guide laid on the mold clamping unit frame 910. The guide of the toggle support 130 may be common to the guide 101 of the movable platen 120.

In the present embodiment, the stationary platen 110 is fixed to the mold clamping unit frame 910, and the toggle support 130 is disposed to be movable in the mold opening and closing direction with respect to the mold clamping unit frame 910. However, the toggle support 130 may be fixed to the mold clamping unit frame 910, and the stationary platen 110 may be disposed to be movable in the mold opening and closing direction with respect to the mold clamping unit frame 910.

The tie bar 140 connects the stationary platen 110 and the toggle support 130 to each other at an interval L in the mold opening and closing direction. A plurality of (for example, four) tie bars 140 may be used. The plurality of tie bars 140 are disposed parallel to each other in the mold opening and closing direction, and extend in accordance with a mold clamping force. At least one of the tie bars 140 may be provided with a tie bar strain detector 141 that measures a strain of the tie bar 140. The tie bar strain detector 141 transmits a signal indicating a measurement result thereof to the control device 700. The measurement result of the tie bar strain detector 141 is used in measuring the mold clamping force or the like.

In the present embodiment, as a mold clamping force detector for measuring the mold clamping force, the tie bar strain detector 141 is used. However, the present invention is not limited thereto. The mold clamping force detector is not limited to a strain gauge type. The mold clamping force detector may be of a piezoelectric type, a capacitive type, a hydraulic type, an electromagnetic type, or the like, and an attachment position thereof is not limited to the tie bar 140.

The toggle mechanism 150 is disposed between the movable platen 120 and the toggle support 130 to connect the movable platen 120 (an example of a first platen) for mold opening and closing of the mold unit 800 to the stationary platen 110 (an example of a second platen). In addition, the toggle mechanism 150 moves the movable platen 120 (the example of the first platen) in the mold opening and closing direction with respect to the toggle support 130. The toggle mechanism 150 has a crosshead 151 that moves in the mold opening and closing direction, and a pair of link groups bent and stretched by a movement of the crosshead 151. Each of the pair of link groups has a first link 152 and a second link 153 which are connected to be freely bent and stretched by a pin or the like. The first link 152 is oscillatingly attached to the movable platen 120 by a pin or the like. The second link 153 is oscillatingly attached to the toggle support 130 by a pin or the like. The second link 153 is attached to the crosshead 151 via a third link 154. When the crosshead 151 is caused to advance and retreat with respect to the toggle support 130, the first link 152 and the second link 153 are bent and stretched, and the movable platen 120 advances and retreats with respect to the toggle support 130.

A configuration of the toggle mechanism 150 is not limited to configurations shown in FIGS. 1 and 2. For example, in FIGS. 1 and 2, the number of nodes in each link group is five, but may be four. One end portion of the third link 154 may be connected to the node between the first link 152 and the second link 153.

The mold clamping motor 160 is attached to the toggle support 130, and operates the toggle mechanism 150. The mold clamping motor 160 causes the crosshead 151 to advance and retreat with respect to the toggle support 130 such that the first link 152 and the second link 153 are bent and stretched, and the movable platen 120 advances and retreats with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts a rotary motion of the mold clamping motor 160 into a linear motion of the crosshead 151. The motion conversion mechanism 170 includes a screw shaft and a screw nut screwed to the screw shaft. A ball or a roller may be interposed between the screw shaft and the screw nut.

The mold clamping unit 100 performs a mold closing process, a pressurizing process, a mold clamping process, a depressurizing process, a mold opening process, and the like under the control of the control device 700.

In the mold closing process, the mold clamping motor 160 is driven to cause the crosshead 151 to advance to a mold closing completion position at a set movement speed, thereby causing the movable platen 120 to advance such that the movable mold 820 touches the stationary mold 810. For example, a position or a movement speed of the crosshead 151 is measured by using a mold clamping motor encoder 161. The mold clamping motor encoder 161 measures rotation of the mold clamping motor 160, and transmits a signal indicating a measurement result thereof to the control device 700.

A crosshead position detector for measuring the position of the crosshead 151 and a crosshead movement speed detector for measuring the movement speed of the crosshead 151 are not limited to the mold clamping motor encoder 161, and a general detector can be used. In addition, a movable platen position detector for measuring a position of the movable platen 120 and a movable platen movement speed detector for measuring a movement speed of the movable platen 120 are not limited to the mold clamping motor encoder 161, and a general detector can be used.

In the pressurizing process, the mold clamping motor 160 is further driven to cause the crosshead 151 to further advance from the mold closing completion position to a mold clamping position, thereby generating a mold clamping force.

In the mold clamping process, the mold clamping motor 160 is driven to maintain the position of the crosshead 151 at the mold clamping position. In the mold clamping process, the mold clamping force generated in the pressurizing process is maintained. In the mold clamping process, a cavity space 801 (refer to FIG. 2) is formed between the movable mold 820 and the stationary mold 810, and the injection unit 300 fills the cavity space 801 with a liquid molding material. A molding product is obtained by solidifying the molding material filled therein.

The number of the cavity spaces 801 may be one or more. In the latter case, a plurality of the molding products can be obtained at the same time. An insert material may be disposed in a portion of the cavity space 801, and the other portion of the cavity space 801 may be filled with the molding material. A molding product in which the insert material and the molding material are integrated with each other can be obtained.

In the depressurizing process, the mold clamping motor 160 is driven to cause the crosshead 151 to retreat from the mold clamping position to a mold opening start position such that the movable platen 120 retreats to reduce the mold clamping force. The mold opening start position and the mold closing completion position may be the same position.

In the mold opening process, the mold clamping motor 160 is driven to cause the crosshead 151 to retreat from the mold opening start position to a mold opening completion position at a set movement speed such that the movable platen 120 retreats and the movable mold 820 is separated from the stationary mold 810. Thereafter, the ejector unit 200 ejects the molding product from the movable mold 820.

Setting conditions in the mold closing process, the pressurizing process, and the mold clamping process are collectively set as a series of setting conditions. For example, the movement speed or positions (including a mold closing start position, a movement speed switching position, the mold closing completion position, and the mold clamping position) of the crosshead 151 and the mold clamping force in the mold closing process and in the pressurizing process are collectively set as a series of setting conditions. The mold closing start position, the movement speed switching position, the mold closing completion position, and the mold clamping position are aligned in this order from a rear side toward a front side, and represent a start point and an end point of a section in which the movement speed is set. The movement speed is set for each section. The number of the movement speed switching positions may be one or more. The movement speed switching position may not be set. Only one of the mold clamping position and the mold clamping force may be set.

Setting conditions in the depressurizing process and in the mold opening process are set in the same manner. For example, the movement speed or positions (the mold opening start position, the movement speed switching position, and the mold opening completion position) of the crosshead 151 in the depressurizing process and in the mold opening process are collectively set as a series of setting conditions. The mold opening start position, the movement speed switching position, and the mold opening completion position are aligned in this order from the front side toward the rear side, and represent the start point and the end point of the section in which the movement speed is set. The movement speed is set for each section. The number of the movement speed switching positions may be one or more. The movement speed switching position may not be set. The mold opening start position and the mold closing completion position may be the same position. In addition, the mold opening completion position and the mold closing start position may be the same position.

Instead of the movement speed, positions, and the like of the crosshead 151, the movement speed, positions, and the like of the movable platen 120 may be set. In addition, instead of the position (for example, the mold clamping position) of the crosshead or the position of the movable platen, the mold clamping force may be set.

The toggle mechanism 150 amplifies a driving force of the mold clamping motor 160, and transmits the driving force to the movable platen 120. An amplification magnification is referred to as a toggle magnification. The toggle magnification is changed according to an angle θ (hereinafter, also referred to as a “link angle θ”) formed between the first link 152 and the second link 153. The link angle θ is obtained from the position of the crosshead 151. When the link angle θ is 180°, the toggle magnification is maximized.

In a case where a mold space of the mold unit 800 is changed due to replacement of the mold unit 800, a temperature change in the mold unit 800, or the like, mold space adjustment is performed so that a predetermined mold clamping force is obtained during the mold clamping. For example, in the mold space adjustment, the interval L between the stationary platen 110 and the toggle support 130 is adjusted so that the link angle θ of the toggle mechanism 150 becomes a predetermined angle at a mold touch time at which the movable mold 820 touches the stationary mold 810.

The mold clamping unit 100 has the mold space adjustment mechanism 180. The mold space adjustment mechanism 180 performs the mold space adjustment by adjusting the interval L between the stationary platen 110 and the toggle support 130. For example, a time for the mold space adjustment is determined from an end point of a molding cycle to a start point of a subsequent molding cycle. For example, the mold space adjustment mechanism 180 has a screw shaft 181 formed in a rear end portion of the tie bar 140, a screw nut 182 held by the toggle support 130 to be rotatable and not to advance and retreat, and a mold space adjustment motor 183 that rotates the screw nut 182 screwed to the screw shaft 181.

The screw shaft 181 and the screw nut 182 are provided for each of the tie bars 140. A rotational driving force of the mold space adjustment motor 183 may be transmitted to a plurality of the screw nuts 182 via a rotational driving force transmitting unit 185. The plurality of screw nuts 182 can be rotated in synchronization with each other. The plurality of screw nuts 182 can be individually rotated by changing a transmission channel of the rotational driving force transmitting unit 185.

For example, the rotational driving force transmitting unit 185 is configured to include a gear. In this case, a driven gear is formed on an outer periphery of each screw nut 182, a driving gear is attached to an output shaft of the mold space adjustment motor 183, and a plurality of intermediate gears meshing with the driven gear and the driving gear are held to be rotatable in a central portion of the toggle support 130. The rotational driving force transmitting unit 185 may be configured to include a belt, a pulley, or the like instead of the gear.

An operation of the mold space adjustment mechanism 180 is controlled by the control device 700. The control device 700 drives the mold space adjustment motor 183 to rotate the screw nut 182. As a result, a position of the toggle support 130 with respect to the tie bar 140 is adjusted, and the interval L between the stationary platen 110 and the toggle support 130 is adjusted. In addition, a plurality of the mold space adjustment mechanisms may be used in combination.

The interval L is measured by using a mold space adjustment motor encoder 184. The mold space adjustment motor encoder 184 measures a rotation amount or a rotation direction of the mold space adjustment motor 183, and transmits a signal indicating a measurement result thereof to the control device 700. The measurement result of the mold space adjustment motor encoder 184 is used in monitoring or controlling the position or the interval L of the toggle support 130. A toggle support position detector for measuring the position of the toggle support 130 and an interval detector for measuring the interval L are not limited to the mold space adjustment motor encoder 184, and a general detector can be used.

The mold clamping unit 100 may include a mold temperature controller that adjusts a temperature of the mold unit 800. The mold unit 800 internally has a flow path of a temperature control medium. The mold temperature controller adjusts the temperature of the mold unit 800 by adjusting a temperature of the temperature control medium supplied to the flow path of the mold unit 800.

The mold clamping unit 100 of the present embodiment is of the horizontal type in which the mold opening and closing direction is the horizontal direction, but may be of a vertical type in which the mold opening and closing direction is an upward-downward direction.

The mold clamping unit 100 of the present embodiment has the mold clamping motor 160 as a drive source. However, a hydraulic cylinder may be provided instead of the mold clamping motor 160. In addition, the mold clamping unit 100 may have a linear motor for mold opening and closing, and may have an electromagnet for mold clamping.

### Ejector Unit

In describing the ejector unit 200, similarly to the description of the mold clamping unit 100, a moving direction of the movable platen 120 during the mold closing (for example, the positive direction of the X-axis) will be defined as forward, and a moving direction of the movable platen 120 during the mold opening (for example, the negative direction of the X-axis) will be defined as rearward.

The ejector unit 200 is attached to the movable platen 120, and advances and retreats together with the movable platen 120. The ejector unit 200 has an ejector rod 210 that ejects a molding product from the mold unit 800, and a drive mechanism 220 that moves the ejector rod 210 in the moving direction (X-axis direction) of the movable platen 120.

The ejector rod 210 is disposed to be able to advance and retreat in a through-hole of the movable platen 120. A front end portion of the ejector rod 210 comes into contact with an ejector plate 826 of the movable mold 820. The front end portion of the ejector rod 210 may be connected to or may not be connected to the ejector plate 826.

For example, the drive mechanism 220 has an ejector motor and a motion conversion mechanism that converts a rotary motion of the ejector motor into a linear motion of the ejector rod 210. The motion conversion mechanism includes a screw shaft and a screw nut screwed to the screw shaft. A ball or a roller may be interposed between the screw shaft and the screw nut.

The ejector unit 200 performs an ejection process under the control of the control device 700. In the ejection process, the ejector rod 210 is caused to advance from a standby position to an ejection position at a set movement speed such that the ejector plate 826 advances to eject the molding product. Thereafter, the ejector motor is driven to cause the ejector rod 210 to retreat at a set movement speed such that the ejector plate 826 retreats to an original standby position.

For example, a position or a movement speed of the ejector rod 210 is measured by using an ejector motor encoder. The ejector motor encoder measures the rotation of the ejector motor, and transmits a signal indicating a measurement result thereof to the control device 700. An ejector rod position detector for measuring the position of the ejector rod 210, and an ejector rod movement speed detector for measuring the movement speed of the ejector rod 210 are not limited to the ejector motor encoder, and a general detector can be used.

### Injection Unit

In describing the injection unit 300, unlike the description of the mold clamping unit 100 or the description of the ejector unit 200, a moving direction of a screw 330 during filling (for example, the negative direction of the X-axis) will be defined as forward, and a moving direction of the screw 330 during plasticizing (for example, the positive direction of the X-axis) will be defined as rearward.

The injection unit 300 is installed on a slide base 301, and the slide base 301 is disposed to be able to advance and retreat with respect to the injection unit frame 920. The injection unit 300 is disposed to be able to advance and retreat with respect to the mold unit 800. The injection unit 300 touches the mold unit 800 and fills the cavity space 801 in the mold unit 800 with the molding material. For example, the injection unit 300 has a cylinder 310 that heats the molding material, a nozzle 320 provided in a front end portion of the cylinder 310, the screw 330 disposed to be able to advance and retreat and to rotate inside the cylinder 310, a plasticizing motor 340 that rotates the screw 330, an injection motor 350 that causes the screw 330 to advance and retreat, and a load detector 360 that measures a load transmitted between the injection motor 350 and the screw 330.

The cylinder 310 heats the molding material supplied into the cylinder 310 from a feed port 311. For example, the molding material includes a resin. For example, the molding material is formed in a pellet shape, and is supplied to the feed port 311 in a solid state. The feed port 311 is formed in a rear portion of the cylinder 310. A cooler 312 such as a water-cooling cylinder is provided on an outer periphery of the rear portion of the cylinder 310. In front of the cooler 312, a heating unit 313 such as a band heater and a temperature measurer 314 are provided on an outer periphery of the cylinder 310.

The cylinder 310 is divided into a plurality of zones in an axial direction (for example, the X-axis direction) of the cylinder 310. The heating unit 313 and the temperature measurer 314 are provided in each of the plurality of zones. The control device 700 controls the heating unit 313 so that a set temperature is set in each of the plurality of zones and a measurement temperature of the temperature measurer 314 reaches the set temperature.

The nozzle 320 is provided in the front end portion of the cylinder 310, and is pressed against the mold unit 800. The heating unit 313 and the temperature measurer 314 are provided on an outer periphery of the nozzle 320. The control device 700 controls the heating unit 313 so that a measurement temperature of the nozzle 320 reaches the set temperature.

The screw 330 is disposed to be able to rotate and to advance and retreat inside the cylinder 310. When the screw 330 is rotated, the molding material is fed forward along a helical groove of the screw 330. The molding material is gradually melted by heat from the cylinder 310 while being fed forward. As the liquid molding material is fed forward of the screw 330 and is accumulated in a front portion of the cylinder 310, the screw 330 retreats. Thereafter, when the screw 330 is caused to advance, the liquid molding material accumulated in front of the screw 330 is injected from the nozzle 320, and fills an inside of the mold unit 800.

As a backflow prevention valve for preventing a backflow of the molding material fed rearward from the front of the screw 330 when the screw 330 is pressed forward, a backflow prevention ring 331 is attached to a front portion of the screw 330 to be able to advance and retreat.

The backflow prevention ring 331 is pressed rearward by a pressure of the molding material in front of the screw 330 when the screw 330 is caused to advance, and retreats relative to the screw 330 to a close position (refer to FIG. 2) at which a flow path of the molding material is closed. Accordingly, the molding material accumulated in front of the screw 330 is prevented from flowing rearward.

On the other hand, the backflow prevention ring 331 is pressed forward by the pressure of the molding material fed forward along the helical groove of the screw 330 when the screw 330 is rotated, and advances relative to the screw 330 to an open position (refer to FIG. 1) at which the flow path of the molding material is open. Accordingly, the molding material is fed forward of the screw 330.

The backflow prevention ring 331 may be of either a co-rotation type rotating together with the screw 330 or a non-co-rotation type that does not rotate together with the screw 330.

The injection unit 300 may have a drive source that causes the backflow prevention ring 331 to advance and retreat with respect to the screw 330 between the open position and the close position.

The plasticizing motor 340 rotates the screw 330. A drive source that rotates the screw 330 is not limited to the plasticizing motor 340, and may be a hydraulic pump, for example.

The injection motor 350 causes the screw 330 to advance and retreat. A motion conversion mechanism that converts a rotary motion of the injection motor 350 into a linear motion of the screw 330 or the like is provided between the injection motor 350 and the screw 330. For example, the motion conversion mechanism has a screw shaft and a screw nut screwed to the screw shaft. A ball or a roller may be provided between the screw shaft and the screw nut. The drive source that causes the screw 330 to advance and retreat is not limited to the injection motor 350, and may be a hydraulic cylinder, for example.

The load detector 360 measures a load transmitted between the injection motor 350 and the screw 330. The measured load is converted into a pressure by the control device 700. The load detector 360 is provided in a load transmission channel between the injection motor 350 and the screw 330, and measures the load acting on the load detector 360.

The load detector 360 transmits a signal of the measured load to the control device 700. The load measured by the load detector 360 is converted into the pressure acting between the screw 330 and the molding material, and is used in controlling or monitoring the pressure received from the molding material by the screw 330, a back pressure against the screw 330, the pressure acting on the molding material from the screw 330, or the like.

A pressure detector for measuring the pressure of the molding material is not limited to the load detector 360, and a general detector can be used. For example, a nozzle pressure sensor or a mold internal pressure sensor may be used. The nozzle pressure sensor is installed in the nozzle 320. The mold internal pressure sensor is installed inside the mold unit 800.

The injection unit 300 performs a plasticizing process, a filling process, a holding pressure process, and the like under the control of the control device 700. The filling process and the holding pressure process may be collectively referred to as an injection process.

In the plasticizing process, the plasticizing motor 340 is driven to rotate the screw 330 at a set rotational speed such that the molding material is fed forward along the helical groove of the screw 330. As a result, the molding material is gradually melted. As the liquid molding material is fed forward of the screw 330 and is accumulated in the front portion of the cylinder 310, the screw 330 retreats. For example, the rotational speed of the screw 330 is measured by using a plasticizing motor encoder 341. The plasticizing motor encoder 341 measures the rotation of the plasticizing motor 340, and transmits a signal indicating a measurement result thereof to the control device 700. A screw rotational speed detector for measuring the rotational speed of the screw 330 is not limited to the plasticizing motor encoder 341, and a general detector can be used.

In the plasticizing process, the injection motor 350 may be driven to apply a set back pressure to the screw 330 in order to limit a sudden retreat of the screw 330. The back pressure applied to the screw 330 is measured by using the load detector 360, for example. When the screw 330 retreats to a plasticizing completion position and a predetermined amount of the molding material is accumulated in front of the screw 330, the plasticizing process is completed.

The position in the moving direction and the rotational speed of the screw 330 in the plasticizing process are collectively set as a series of setting conditions. For example, a plasticizing start position, a rotational speed switching position, and the plasticizing completion position are set. These positions are aligned in this order from the front side toward the rear side, and represent a start point and an end point of a section in which the rotational speed is set. The rotational speed is set for each section. The number of the rotational speed switching positions may be one or more. The rotational speed switching position may not be set. In addition, the back pressure is set for each section.

In the filling process, the injection motor 350 is driven to cause the screw 330 to advance at a set movement speed, and the cavity space 801 inside the mold unit 800 is filled with the liquid molding material accumulated in front of the screw 330. The position or the movement speed of the screw 330 is measured by using an injection motor encoder 351, for example. The injection motor encoder 351 measures the rotation of the injection motor 350, and transmits a signal indicating a measurement result thereof to the control device 700. When the position of the screw 330 reaches a set position, the filling process is switched to the holding pressure process (so-called V/P switching). The position where the V/P switching is performed will be referred to as a V/P switching position. The set movement speed of the screw 330 may be changed in accordance with the position, a time, or the like of the screw 330.

The position and the movement speed of the screw 330 in the filling process are collectively set as a series of setting conditions. For example, a filling start position (also referred to as an “injection start position”), the movement speed switching position, and the V/P switching position are set. These positions are aligned in this order from the rear side toward the front side, and represent the start point and the end point of the section in which the movement speed is set. The movement speed is set for each section. The number of the movement speed switching positions may be one or more. The movement speed switching position may not be set.

An upper limit of the pressure of the screw 330 is set for each section in which the movement speed of the screw 330 is set. The pressure of the screw 330 is measured by the load detector 360. In a case where the pressure of the screw 330 is equal to or lower than a setting pressure, the screw 330 advances at a set movement speed. On the other hand, in a case where the pressure of the screw 330 exceeds the setting pressure, in order to protect the mold, the screw 330 is caused to advance at a movement speed slower than the set movement speed so that the pressure of the screw 330 is equal to or lower than the setting pressure.

After the position of the screw 330 reaches the V/P switching position in the filling process, the screw 330 may be temporarily stopped at the V/P switching position, and thereafter, the V/P switching may be performed. Immediately before the V/P switching, instead of the screw 330 being stopped, the screw 330 may be caused to advance at a low speed, or may be caused to retreat at a low speed. In addition, a screw position detector for measuring the position of the screw 330 and a screw movement speed detector for measuring the movement speed of the screw 330 are not limited to the injection motor encoder 351, and a general detector can be used.

In the holding pressure process, the injection motor 350 is driven to press the screw 330 forward. A pressure (hereinafter, also referred to as a “holding pressure”) of the molding material in a front end portion of the screw 330 is held at a set pressure, and the molding material remaining inside the cylinder 310 is pressed toward the mold unit 800. An insufficient amount of the molding material due to cooling shrinkage inside the mold unit 800 can be replenished. The holding pressure is measured by using the load detector 360, for example. A set value of the holding pressure may be changed depending on an elapsed time from the start of the holding pressure process or the like. A plurality of holding pressures and a plurality of holding times for holding the holding pressures in the holding pressure process may be respectively set, or may be collectively set as a series of setting conditions.

In the holding pressure process, the molding material in the cavity space 801 inside the mold unit 800 is gradually cooled, and when the holding pressure process is completed, an inlet of the cavity space 801 is closed by the solidified molding material. This state is referred to as gate seal, and prevents the backflow of the molding material from the cavity space 801. After the holding pressure process, a cooling process starts. In the cooling process, the molding material inside the cavity space 801 is solidified. In order to shorten a molding cycle time, the plasticizing process may be performed during the cooling process.

The injection unit 300 of the present embodiment is of an in-line screw type, but may be of a pre-plasticizing type. The injection unit of the pre-plasticizing type supplies the molding material melted inside a plasticizing cylinder to an injection cylinder, and the molding material is injected into the mold unit from the injection cylinder. Inside the plasticizing cylinder, the screw is disposed to be rotatable and not to be able to advance and retreat, or the screw is disposed to be rotatable and to be able to advance and retreat. Meanwhile, a plunger is disposed to be able to advance and retreat inside the injection cylinder.

In addition, the injection unit 300 of the present embodiment is of a horizontal type in which the axial direction of the cylinder 310 is a horizontal direction, but may be of a vertical type in which the axial direction of the cylinder 310 is an upward-downward direction. The mold clamping unit combined with a vertical type injection unit 300 may be of the vertical type or the horizontal type. Similarly, the mold clamping unit combined with a horizontal type injection unit 300 may be of the horizontal type or the vertical type.

### Moving Unit

In describing the moving unit 400, similarly to the description of the injection unit 300, a moving direction of the screw 330 during the filling (for example, the negative direction of the X-axis) will be defined as forward, and a moving direction of the screw 330 during the plasticizing (for example, the positive direction of the X-axis) will be defined as rearward.

The moving unit 400 causes the injection unit 300 to advance and retreat with respect to the mold unit 800. The moving unit 400 presses the nozzle 320 against the mold unit 800, thereby generating a nozzle touch pressure. The moving unit 400 includes a hydraulic pump 410, a motor 420 serving as a drive source, a hydraulic cylinder 430 serving as a hydraulic actuator, and the like.

The hydraulic pump 410 has a first port 411 and a second port 412. The hydraulic pump 410 is a pump that can rotate in both directions, and switches rotation directions of the motor 420 such that a hydraulic fluid (for example, oil) is suctioned from any one of the first port 411 and the second port 412, and is discharged from the other to generate a hydraulic pressure. The hydraulic pump 410 can suction the hydraulic fluid from a tank, and can discharge the hydraulic fluid from any one of the first port 411 and the second port 412.

The motor 420 operates the hydraulic pump 410. The motor 420 drives the hydraulic pump 410 in a rotation direction and with a rotation torque in accordance with a control signal transmitted from the control device 700. The motor 420 may be an electric motor, or may be an electric servo motor.

The hydraulic cylinder 430 has a cylinder body 431, a piston 432, and a piston rod 433. The cylinder body 431 is fixed to the injection unit 300. The piston 432 partitions an inside of the cylinder body 431 into a front chamber 435 serving as a first chamber and into a rear chamber 436 serving as a second chamber. The piston rod 433 is fixed to the stationary platen 110.

The front chamber 435 of the hydraulic cylinder 430 is connected to the first port 411 of the hydraulic pump 410 via a first flow path 401. The hydraulic fluid discharged from the first port 411 is supplied to the front chamber 435 via the first flow path 401, whereby the injection unit 300 is pressed forward. The injection unit 300 advances, and the nozzle 320 is pressed against the stationary mold 810. The front chamber 435 functions as a pressure chamber that generates the nozzle touch pressure of the nozzle 320 by means of the pressure of the hydraulic fluid supplied from the hydraulic pump 410.

On the other hand, the rear chamber 436 of the hydraulic cylinder 430 is connected to the second port 412 of the hydraulic pump 410 via a second flow path 402. The hydraulic fluid discharged from the second port 412 is supplied to the rear chamber 436 of the hydraulic cylinder 430 via the second flow path 402, whereby the injection unit 300 is pressed rearward. The injection unit 300 retreats, and the nozzle 320 is separated from the stationary mold 810.

In the present embodiment, the moving unit 400 includes the hydraulic cylinder 430, but the present invention is not limited thereto. For example, instead of the hydraulic cylinder 430, an electric motor and a motion conversion mechanism that converts a rotary motion of the electric motor into a linear motion of the injection unit 300 may be used.

### Control Device

For example, the control device 700 is configured to include a computer, and has a central processing unit (CPU) 701, a storage medium 702 such as a memory, an input interface 703, and an output interface 704 as shown in FIGS. 1 and 2. The control device 700 performs various types of control by causing the CPU 701 to execute a program stored in the storage medium 702. In addition, the control device 700 receives a signal from the outside through the input interface 703, and transmits the signal to the outside through the output interface 704.

The control device 700 repeatedly performs the plasticizing process, the mold closing process, the pressurizing process, the mold clamping process, the filling process, the holding pressure process, the cooling process, the depressurizing process, the mold opening process, the ejection process, and the like, thereby repeatedly manufacturing the molding product. A series of operations for obtaining the molding product, for example, an operation from the start of the plasticizing process to the start of the subsequent plasticizing process, will be referred to as a “shot” or a “molding cycle”. In addition, a time required for one shot will be referred to as a “molding cycle time” or a “cycle time”.

For example, one molding cycle has the plasticizing process, the mold closing process, the pressurizing process, the mold clamping process, the filling process, the holding pressure process, the cooling process, the depressurizing process, the mold opening process, and the ejection process in this order. The order described here is the order of the start times of the respective processes. The filling process, the holding pressure process, and the cooling process are performed during the mold clamping process. The start of the mold clamping process may coincide with the start of the filling process. The completion of the depressurizing process coincides with the start of the mold opening process.

A plurality of processes may be performed at the same time in order to shorten the molding cycle time. For example, the plasticizing process may be performed during the cooling process of the previous molding cycle or may be performed during the mold clamping process. In this case, the mold closing process may be performed in an initial stage of the molding cycle. In addition, the filling process may start during the mold closing process. In addition, the ejection process may start during the mold opening process. In a case where an on-off valve for opening and closing a flow path of the nozzle 320 is provided, the mold opening process may start during the plasticizing process. The reason is as follows. Even in a case where the mold opening process starts during the plasticizing process, when the on-off valve closes the flow path of the nozzle 320, the molding material does not leak from the nozzle 320.

One molding cycle may include a process other than the plasticizing process, the mold closing process, the pressurizing process, the mold clamping process, the filling process, the holding pressure process, the cooling process, the depressurizing process, the mold opening process, and the ejection process.

For example, after the holding pressure process is completed and before the plasticizing process starts, a pre-plasticizing suck-back process of causing the screw 330 to retreat to a preset plasticizing start position may be performed. The pressure of the molding material accumulated in front of the screw 330 before the plasticizing process starts can be reduced, and a sudden retreat of the screw 330 when the plasticizing process starts can be prevented.

In addition, after the plasticizing process is completed and before the filling process starts, a post-plasticizing suck-back process may be performed in which the screw 330 is caused to retreat to the preset filling start position (also referred to as the “injection start position”). The pressure of the molding material accumulated in front of the screw 330 before the filling process starts can be reduced, and a leakage of the molding material from the nozzle 320 before the filling process starts can be prevented.

The control device 700 is connected to an operation device 750 that receives an input operation of a user, and to a display device 760 that displays a screen. For example, the operation device 750 and the display device 760 may be integrated with each other in a form of a touch panel 770. The touch panel 770 serving as the display device 760 displays the screen under the control of the control device 700. For example, the screen of the touch panel 770 may display settings of the injection molding machine 10, and information on a current state of the injection molding machine 10. In addition, for example, the screen of the touch panel 770 may display a button for accepting the input operation of the user or an operation portion such as an input field. The touch panel 770 serving as the operation device 750 detects an input operation of the user on the screen, and outputs a signal corresponding to the input operation to the control device 700. In this manner, for example, while confirming information displayed on the screen, the user can perform setting (including an input of a set value) of the injection molding machine 10 by operating the operation portion provided on the screen. In addition, the user can operate the injection molding machine 10 corresponding to the operation portion by operating the operation portion provided on the screen. For example, the operation of the injection molding machine 10 may be an operation (including stopping) of the mold clamping unit 100, the ejector unit 200, the injection unit 300, the moving unit 400, or the like. In addition, the operation of the injection molding machine 10 may be switching between the screens displayed on the touch panel 770 serving as the display device 760.

A case has been described in which the operation device 750 and the display device 760 of the present embodiment are integrated with each other as the touch panel 770. However, both of these may be independently provided. In addition, a plurality of the operation devices 750 may be provided. The operation device 750 and the display device 760 are disposed on the operation side (a negative direction of the Y-axis) of the mold clamping unit 100 (more specifically, the stationary platen 110).

### Configuration of Toggle Mechanism

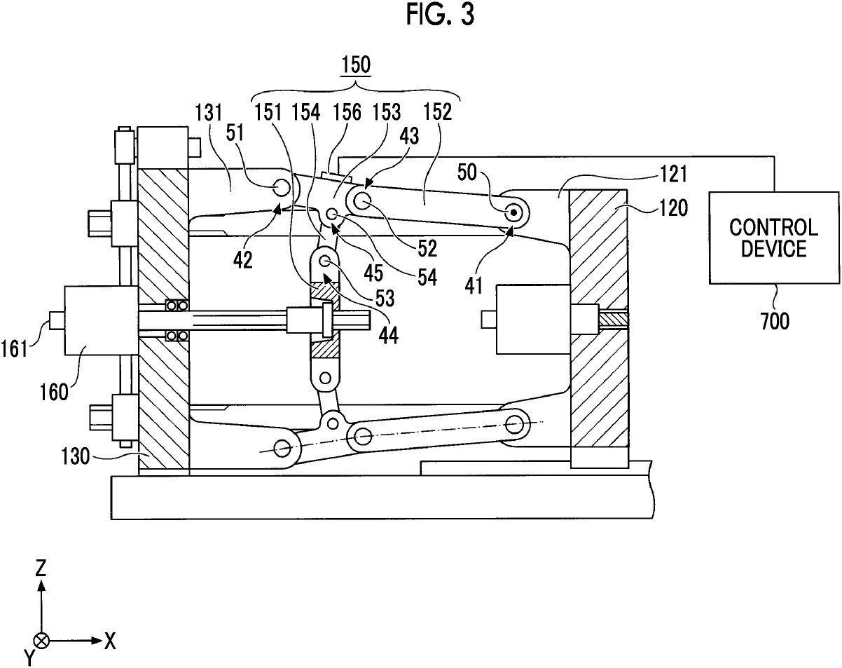

Next, a configuration of the toggle mechanism 150 will be described. FIG. 3 is a configuration diagram of the toggle mechanism 150 included in the injection molding machine 10 according to the one embodiment.

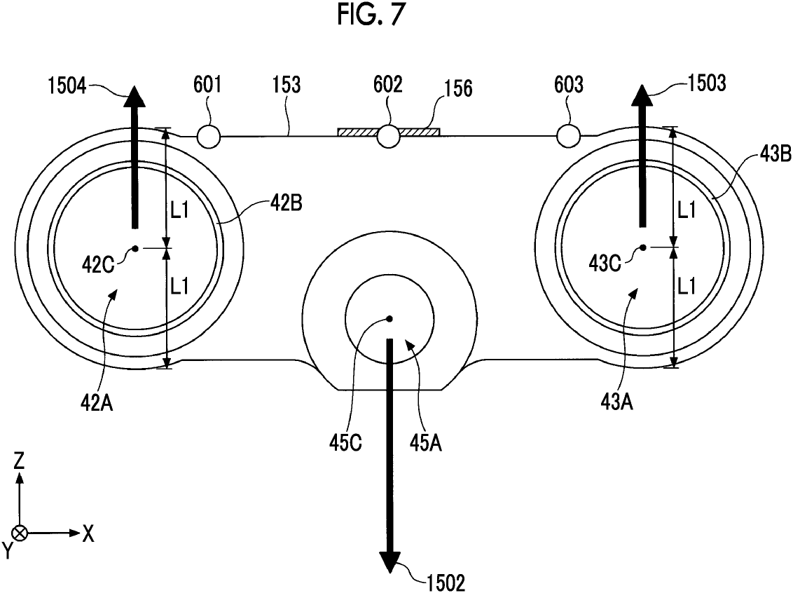

As shown in FIG. 3, a link connection portion 131 of the toggle support 130 is connected to the second link 153 by a second connection mechanism 42. A connection pin 51 is used for connection by the second connection mechanism 42. The connection pin 51 is fixed to a connection hole of the link connection portion 131 of the toggle support 130 in a non-rotatable manner, and can slide on a bushing 42B (refer to FIG. 7) press-fitted into a connection hole 42A (refer to FIG. 7) of the second link 153. A sliding surface between the bushing 42B and the connection pin 51 is lubricated.

The first link 152 and the second link 153 are connected to each other by a third connection mechanism 43. A connection pin 52 is used for connection by the third connection mechanism 43. The connection pin 52 is fixed to one connection hole of the first link 152 in a non-rotatable manner, and can slide on a bushing 43B (refer to FIG. 7) press-fitted into a connection hole 43A (refer to FIG. 7) of the second link 153, which is the other connection member. A sliding surface between the bushing 43B and the connection pin 52 is lubricated.

Similarly, connection pins 50, 53, and 54 are respectively fixed to one set of connection members in connection mechanisms (a first connection mechanism 41, a fourth connection mechanism 44, and a fifth connection mechanism 45), which will be described later, in a non-rotatable manner, and can slide on bushings press-fitted into the other set of connection members. Sliding surfaces between the bushings and the connection pins 50, 53 and 54 are lubricated.

A link connection portion 121 of the movable platen 120 is connected to the first link 152 by the first connection mechanism 41. The connection pin 50 is used for connection by the first connection mechanism 41.

The crosshead 151 is connected to the third link 154 by the fourth connection mechanism 44. The connection pin 53 is used for connection by the fourth connection mechanism 44. The third link 154 is connected to the second link 153 on a substantially positive direction side of the Z-axis by the fifth connection mechanism 45. The connection pin 54 is used for connection by the fifth connection mechanism 45.

In each process of mold closing, pressurizing, mold clamping, depressurizing, and mold opening, the crosshead 151 is moved in the X-axis direction by a thrust force generated by driving the mold clamping motor 160. In a case where the crosshead 151 moves in the X-axis direction, the second link 153 to which the crosshead 151 is connected via the third link 154 also moves. The second link 153 moves about the second connection mechanism 42 so as to draw an arc on an XZ-axis plane. Accordingly, the first link 152 and the second link 153 are bent and stretched, and the movable platen 120 advances and retreats with respect to the toggle support 130.

The second link 153 of the present embodiment is provided with a strain gauge 156 on a side surface on the substantially positive direction side of the Z-axis. A signal generated by the strain gauge 156 is transmitted to the control device 700. The control device 700 then determines whether or not wear has occurred in the connection mechanism (for example, the second connection mechanism 42 and the third connection mechanism 43) connected to the second link 153 via the signal from the strain gauge 156.

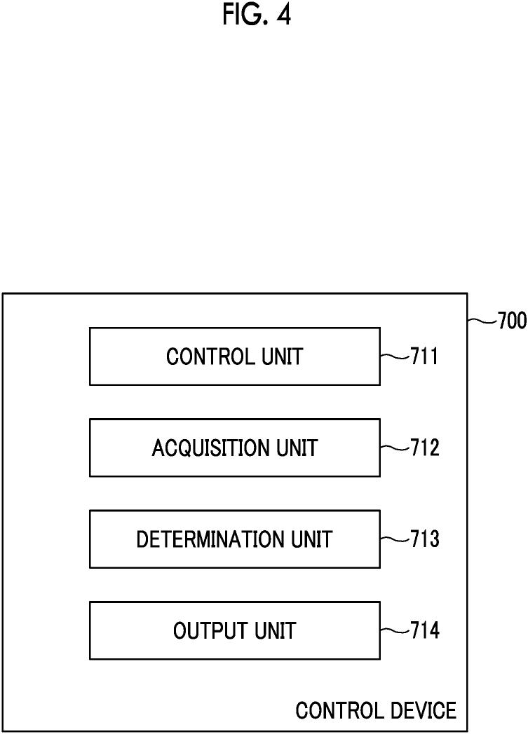

FIG. 4 is a diagram showing a configuration example of the control device 700 according to the present embodiment. As shown in FIG. 4, the configuration shown in FIG. 4 is realized by the CPU 701 provided in the control device 700. In addition, the configuration shown in FIG. 4 may be realized by hardware connection, may be realized by software control, or may be realized by a combination of hardware connection and software control.

As shown in FIG. 4, the control device 700 includes a control unit 711, an acquisition unit 712, a determination unit 713, and an output unit 714.

The control unit 711 controls the mold clamping motor 160 in each process of mold closing, pressurizing, mold clamping, depressurizing, and mold opening. For example, in the depressurizing process, the control unit 711 drives and controls the mold clamping motor 160 to cause the crosshead 151 to retreat from the mold clamping position to the mold opening start position.

The acquisition unit 712 acquires the amount of strain (an example of the amount of change) generated in the second link 153 based on the signal (measured value) in the depressurizing process from the strain gauge 156 (an example of a detection unit) provided in the second link 153 (an example of a link member). In the present embodiment, it is determined whether or not wear has occurred according to the amount of strain acquired in the depressurizing process. Therefore, the strain generated in the second link 153 of the present embodiment will be described.

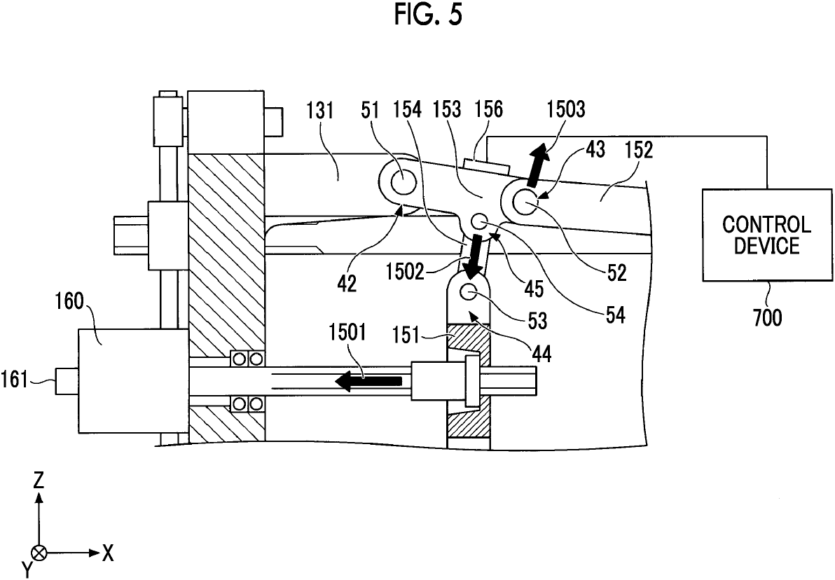

FIG. 5 is a diagram showing forces generated in the toggle mechanism 150 in the depressurizing process according to the one embodiment. As shown in FIG. 5, the thrust force generated by driving the mold clamping motor 160 generates a force 1501 for moving the crosshead 151 in the negative direction of the X-axis. Via the movement of the crosshead 151 in the negative direction of the X-axis, the third link 154 connected by the fourth connection mechanism 44 also starts moving in the negative direction of the X-axis.

The second link 153 is also connected to the third link 154 by the fifth connection mechanism 45 provided on a substantially negative direction side of the Z-axis. Therefore, with the movement of the third link 154, a force 1502 for moving the second link 153 about the second connection mechanism 42 to the substantially negative direction side of the Z-axis where the third link 154 is present is generated. In a case where wear has occurred in the third connection mechanism 43 when the second link 153 moves in response to the force 1502, friction occurs between the second link 153 and the connection pin 52 in the third connection mechanism 43, and a force 1503 is generated.

In a normal depressurizing process, the mold clamping force decreases, so that the strain generated in the second link 153 decreases. However, in a case where wear has occurred in the connection mechanism such as the third connection mechanism 43, a force in a direction opposite to the force 1502 is generated from the connection mechanism, so that the strain generated in the second link 153 increases. Therefore, in the present embodiment, it is determined whether or not wear has occurred based on whether or not the strain increases in the depressurizing process.

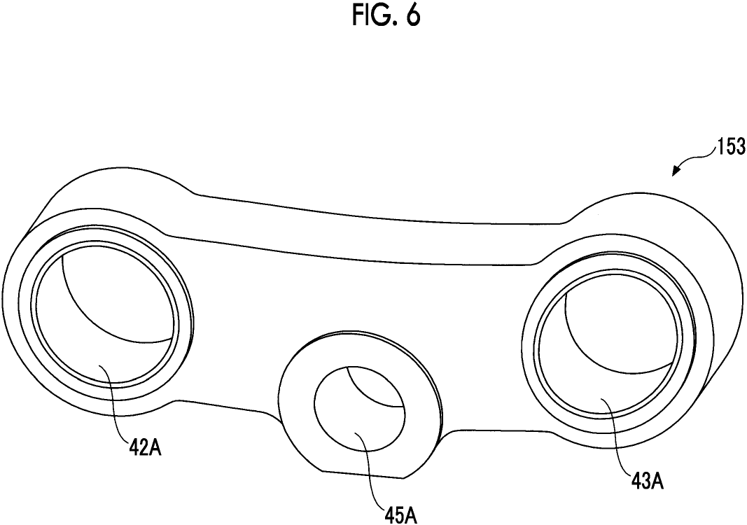

FIG. 6 is a perspective view showing a shape of the second link 153 according to the present embodiment, and FIG. 7 is a front view showing the shape of the second link 153 according to the present embodiment.

The second link 153 shown in FIGS. 6 and 7 is formed of a casting. The second link 153 of the present embodiment is one of a plurality of links (an example of a plurality of link members) constituting the toggle mechanism 150, and has the connection hole 42A (an example of a first connection portion) for forming the second connection mechanism 42 and the connection hole 43A (an example of the first connection portion) for forming the third connection mechanism 43 in order to connect the stationary platen 110 (a second platen) and the movable platen 120 (a first platen).

In the second link 153, the connection hole 42A and the connection hole 43A are formed so that distances L1 from a center 42C of the connection hole 42A and a center 43C of the connection hole 43A to side surfaces in a substantially positive direction of the Z-axis and distances L1 to side surfaces in a substantially negative direction of the Z-axis are equal to each other.

Furthermore, the second link 153 of the present embodiment has a connection hole 45A (an example of a second connection portion) that forms the fifth connection mechanism 45 in order to transmit the mold clamping force from the mold clamping motor 160 (an example of a drive source) to the mold unit 800.

A center 45C of the connection hole 45A exists substantially at the center with respect to a length of the second link 153 in the X-axis direction. In addition, the center 45C of the connection hole 45A exists at a position closer to a negative direction side of the Z-axis. Accordingly, the second link 153 can be connected to the third link 154 existing in the negative direction of the Z-axis.

The bushing 42B is fitted into the connection hole 42A of the second link 153 by using shrink-fitting. Since the bushing 42B has the sliding surface on an inside thereof, the bushing 42B functions as a bearing of the connection pin 51 provided to be in contact with the inside.

Similarly, the bushing 43B is fitted into the connection hole 43A of the second link 153 by using shrink-fitting. Since the bushing 43B has the sliding surface on an inside thereof, the bushing 43B functions as a bearing of the connection pin 52 provided to be in contact with the inside.

For example, in a case where the bushing 43B is worn, a friction coefficient of the sliding surface increases. Accordingly, when the force 1502 in the negative direction of the Z-axis from the third link 154 is generated in the connection hole 45A forming the fifth connection mechanism 45, in a case where a slip is reduced by the friction that has occurred inside the bushing 43B, the force 1503 in the positive direction of the Z-axis is generated.

In addition, in a case where the bushing 42B is worn, a friction coefficient of the sliding surface increases. Accordingly, when the force 1502 in the negative direction of the Z-axis is generated in the connection hole 45A forming the fifth connection mechanism 45, in a case where a slip is reduced by the friction that has occurred inside the bushing 42B, a force 1504 in the positive direction of the Z-axis is generated.

Due to these forces, strain is generated in each of a region 601, a region 602, and a region 603 among side surfaces existing on a positive direction side of the Z-axis of the second link 153. Therefore, in the control device 700 of the present embodiment, the strain generated in any one of these regions 601 to 603 is measured to determine whether or not wear has occurred. In the present embodiment, an example in which the strain gauge 156 (an example of the detection unit) is provided in the region 602 has been described. However, the strain may be measured in the other regions 601 and 603 to determine whether or not wear has occurred.

Returning to FIG. 4, the determination unit 713 determines whether or not the amount of strain acquired by the acquisition unit 712 exceeds a predetermined threshold T1.

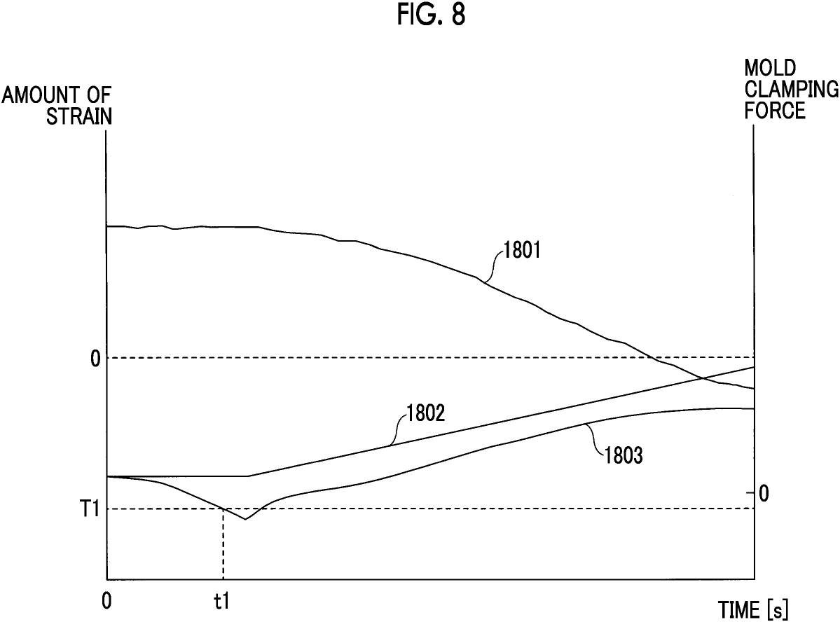

FIG. 8 is a diagram illustrating a change in the amount of strain acquired by the acquisition unit 712 in the depressurizing process of the present embodiment. In the example shown in FIG. 8, a horizontal axis indicates lapse of time, and time “0” is a time when the depressurizing starts. A vertical axis indicates the amount of strain and the mold clamping force.

As shown in FIG. 8, after the depressurizing starts, the mold clamping force 1801 decreases with the lapse of time and approaches a mold clamping force of “0”.

In the example shown in FIG. 8, a change 1802 of the amount of strain in a case where wear has not occurred and a change 1803 of the amount of strain when wear has occurred are shown. In the example shown in FIG. 8, strain has already been generated at the time of the start of depressurizing due to the mold clamping force in the mold clamping process. In the case where wear has not occurred, as indicated by the change 1802 of the amount of strain, after a predetermined time elapses, the amount of strain approaches an amount of strain of “0”.

On the other hand, in the case where wear has occurred, as indicated by the change 1803 of the amount of strain, after the depressurizing starts, an absolute value of the amount of strain increases, and then gradually decreases. In the present embodiment, the threshold T1 (absolute value) is set as a criterion for determining whether or not wear has occurred.

Therefore, since the absolute value of the amount of strain becomes larger than the threshold T1 at time t1, the determination unit 713 determines that at least one of the bushings 42B and 43B of the second link 153 is worn.

In addition, in the present embodiment, an example has been described in which the threshold T1 which is a reference of the absolute value of the amount of strain is set. However, the threshold T1 is not limited to a value as the reference of the absolute value of the amount of strain, and for example, a threshold may be provided for a rate of change in the amount of strain.

The output unit 714 outputs a determination result by the determination unit 713. As an output destination of the determination result, for example, the display device 760 can be considered. However, the output destination may also be a terminal device used by a worker performing a remote operation, a monitoring center that monitors the injection molding machine, or the like.

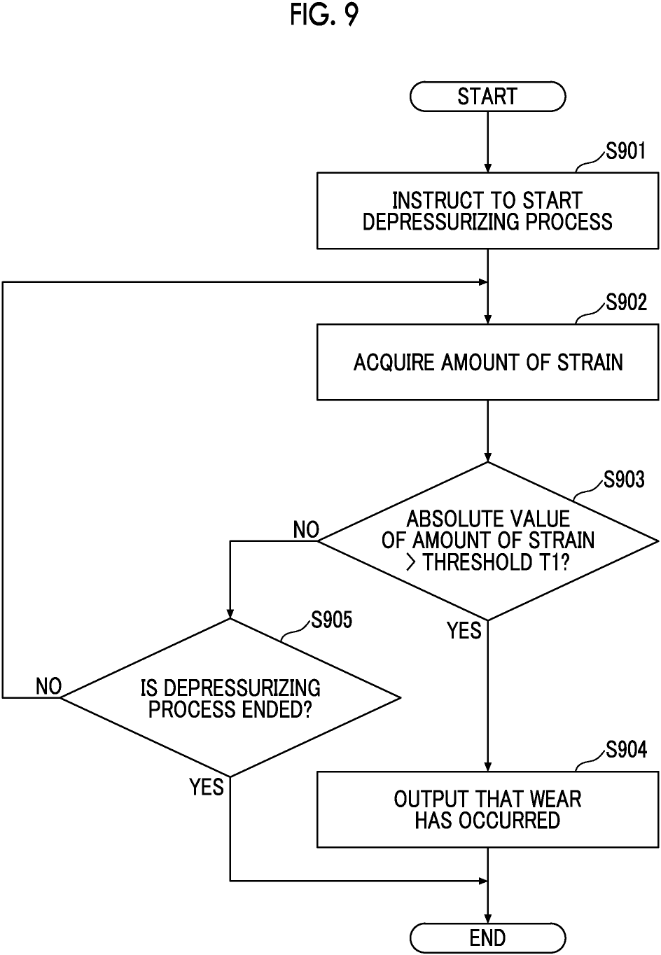

Next, a procedure of a process of determining whether or not wear has occurred via the control device 700 according to the present embodiment will be described. FIG. 9 is a flowchart showing the procedure of the process of determining whether or not wear has occurred via the control device 700 according to the present embodiment. In the flowchart shown in FIG. 9, it is assumed that processes up to the mold clamping process have proceeded.

First, after the mold clamping process is completed, the control unit 711 instructs the mold clamping motor 160 to start the depressurizing process (S901). Accordingly, the mold clamping motor 160 in the depressurizing process starts controlling the crosshead 151 to move in the negative direction of the X-axis.

Next, the acquisition unit 712 acquires the amount of strain from the signal output from the strain gauge 156 (S902).

The determination unit 713 determines whether or not the absolute value of the acquired amount of strain is larger than the threshold T1 (S903). In a case where it is determined that the absolute value of the acquired amount of strain is larger than the threshold T1 (Yes in S903), the output unit 714 outputs to the display device 760 or the like that wear has occurred (S904), and the process is ended.

On the other hand, in a case where the determination unit 713 determines that the absolute value of the acquired amount of strain is equal to or less than the threshold T1 (No in S903), the determination unit 713 determines whether or not the depressurizing process is completed (S905). In a case where it is determined that the depressurizing process is not completed (No in S905), the process is performed again from S902.

On the other hand, in a case where the determination unit 713 determines that the depressurizing process is completed (Yes in S905), the process is ended.

In the present embodiment, by performing the above-described process, it is possible to determine whether or not the wear has occurred based on the amount of strain in the depressurizing process.

### Modification Example of One Embodiment

In addition, in the above-described embodiment, the case where a monitoring device of the injection molding machine 10 is the control device 700 has been described. However, in the above-described embodiment, the monitoring device of the injection molding machine 10 is not limited to the control device 700, and may be any device capable of monitoring the injection molding machine 10. As a modification example, the monitoring device of the injection molding machine 10 may be a monitoring center connected to the injection molding machine 10 via a network. In this case, the monitoring center receives information indicating that the depressurizing process has started and information indicating the amount of strain acquired from the strain gauge 156 via a public network. Then, the monitoring center determines whether or not the wear has occurred based on the received information.

Furthermore, a portable diagnostic device owned by a worker who periodically diagnoses the injection molding machine 10 may be used. When performing the diagnosis, the worker attaches the strain gauge 156 to any one of the regions 601 to 603 of the second link 153 described above. The attached strain gauge 156 is connected to the diagnostic device. Then, the diagnostic device determines whether or not wear has occurred based on whether or not the amount of strain indicated by the signal received from the strain gauge 156 is larger the threshold T1.

### Another Embodiment

In the one embodiment, an example has been described in which the strain gauge 156 is used to measure the amount of strain as the amount of change generated in the second link 153 (an example of the link member). However, in the above-described embodiment, the amount of change generated in the second link 153 (an example of the link member) is not limited to the amount of strain. Therefore, in another embodiment, a case where an acceleration is measured as the amount of change generated in the second link 153 will be described. In the present embodiment, the same reference numerals are assigned to the same configurations as those in the one embodiment, and description thereof will be omitted.

In the present embodiment, an acceleration sensor is provided in the second link 153 (an example of the link member) instead of the strain gauge 156. In the present embodiment, the acceleration sensor is provided in the region 602 of the second link 153 shown in FIG. 7. Although the acceleration sensor is provided in the region 602 in the present embodiment, the acceleration sensor may also be provided in another region.

The acquisition unit 712 acquires an acceleration (an example of the amount of change) generated in the second link 153 based on a signal (measured value) in the depressurizing process from the acceleration sensor provided in the second link 153 (an example of the link member). In the present embodiment, it is determined whether or not wear has occurred according to the acceleration acquired in the depressurizing process. As described above, in a case where the bushings 43B and 42B are worn, the friction coefficient of the sliding surface increases. Therefore, in a case where the force 1502 is generated in the depressurizing process, vibration (acceleration) is generated in the region 602 due to the friction that has occurred inside the bushings 43B and 42B.

The determination unit 713 determines whether or not an absolute value of the acceleration acquired by the acquisition unit 712 exceeds a predetermined threshold T2.

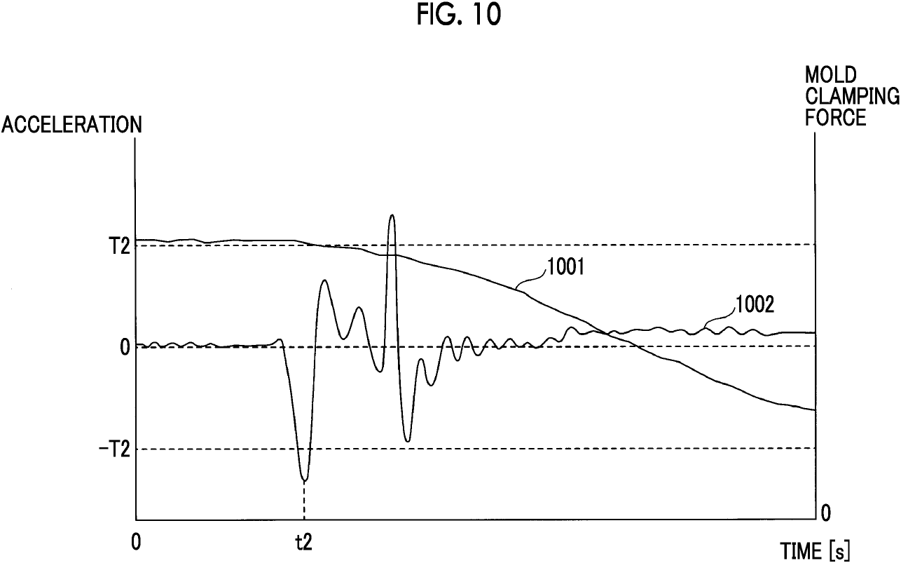

FIG. 10 is a diagram illustrating a change in the acceleration acquired by the acquisition unit 712 in the depressurizing process of the present embodiment. In the example shown in FIG. 10, a horizontal axis indicates lapse of time, and time “0” is a time when the depressurizing starts. A vertical axis represents the acceleration and the mold clamping force.

As shown in FIG. 10, after the depressurizing starts, a mold clamping force 1001 decreases with the lapse of time and approaches a mold clamping force of “0”.

In the example shown in FIG. 10, a change 1002 of the acceleration in a case where wear has occurred is shown. In the example shown in FIG. 10, acceleration (vibration) is not generated at the time of the start of depressurizing. In a case where wear has occurred in the bushings 42B and 43B of the second link 153, acceleration (vibration) is generated when the second link 153 moves about the second connection mechanism 42 to draw an arc. In the present embodiment, the threshold T2 (absolute value) is set as a criterion for determining whether or not wear has occurred.

The determination unit 713 determines an abnormality in a case where the absolute value of the acceleration (vibration) is equal to or larger than the predetermined threshold T2. Therefore, since the absolute value of the acceleration becomes larger than the threshold T2 at time t2, the determination unit 713 determines that at least one of the bushings 42B and 43B of the second link 153 is worn. Then, the output unit 714 outputs the determination result by the determination unit 713.

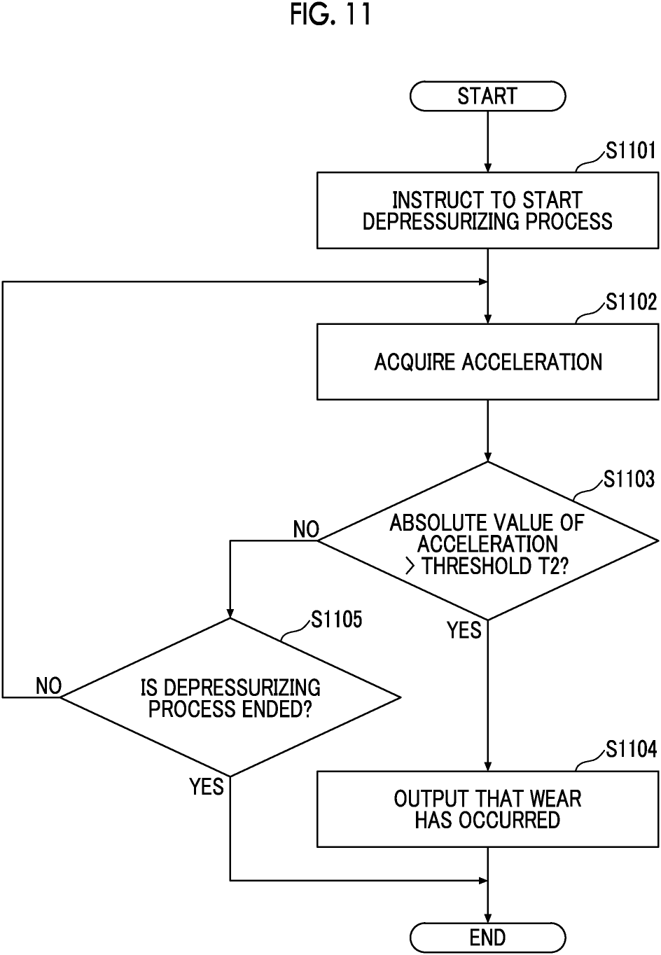

Next, a procedure of a process of determining whether or not wear has occurred via the control device 700 according to the present embodiment will be described. FIG. 11 is a flowchart showing the procedure of the process of determining whether or not wear has occurred via the control device 700 according to the present embodiment. In the flowchart shown in FIG. 11, it is assumed that processes up to the mold clamping process have proceeded.

First, after the mold clamping process is completed, the control unit 711 instructs the mold clamping motor 160 to start the depressurizing process (S1101).

Next, the acquisition unit 712 acquires the acceleration from the signal output from the acceleration sensor (S1102).

The determination unit 713 determines whether or not the absolute value of the acquired acceleration is larger than the threshold T2 (S1103). In a case where it is determined that the absolute value of the acquired acceleration is larger than the threshold T2 (Yes in S1103), the output unit 714 outputs to the display device 760 or the like that wear has occurred (S1104), and the process is ended.

On the other hand, in a case where the determination unit 713 determines that the absolute value of the acquired acceleration is equal to or less than the threshold T2 (No in S1103), the determination unit 713 determines whether or not the depressurizing process is completed (S1105). In a case where it is determined that the depressurizing process is not completed (No in S1105), the process is performed again from S1102.

On the other hand, in a case where the determination unit 713 determines that the depressurizing process is completed (Yes in S1105), the process is ended.

In the present embodiment, by performing the above-described process, it is possible to determine whether or not the wear has occurred based on the acceleration in the depressurizing process.

### Modification Example of Another Embodiment

Similar to the modification example of the one embodiment, in another embodiment as well, the monitoring device of the injection molding machine 10 may be any device capable of monitoring the injection molding machine 10, and for example, may be a monitoring center connected to the injection molding machine 10 via a network or a portable diagnostic device owned by a worker who diagnoses the injection molding machine 10.

In addition, although an example of determining whether or not wear has occurred in the second link 153 has been described in the above-described embodiments and modification examples, the determination is not limited to the second link 153, and may be a plurality of link members constituting the toggle mechanisms 150 and a link member to which a fastening force is transmitted from the mold clamping motor 160.

In the above-described embodiments and modification examples, it is determined whether or not wear has occurred based on the amount of change in strain, acceleration, or the like generated in the second link 153 (an example of the link member) when the depressurizing process is performed. In a method of the present embodiment, unlike in the related art, it is not necessary to make a comparison with a state before the wear, so that the wear can be easily detected. Furthermore, when the measurement is performed, whether or not wear has occurred can be diagnosed by providing the strain gauge 156 or the acceleration sensor on the positive direction side of the Z-axis of the second link 153 in the toggle mechanism 150, so that it is possible to reduce a burden during the diagnosis.

Although the embodiments of the monitoring device of the injection molding machine according to the present invention have been described above, the present invention is not limited to the above-described embodiments. Various changes, modifications, substitutions, additions, deletions, and combinations are possible within the scope described in the claims. As a matter of course, all of these also belong to the technical scope of the present invention.

It should be understood that the invention is not limited to the above-described embodiment, but may be modified into various forms on the basis of the spirit of the invention. Additionally, the modifications are included in the scope of the invention.

What is claimed is:

1. A monitoring device of an injection molding machine comprising:
an acquisition unit that acquires, based on a measured value in a depressurizing process from a detection unit provided in a link member of a toggle mechanism, an amount of change generated in the link member; and
a determination unit that determines whether or not the amount of change acquired by the acquisition unit exceeds a predetermined threshold.

2. The monitoring device of an injection molding machine according to claim 1,
wherein the amount of change generated in the link member acquired by the acquisition unit is an amount of strain generated in the link member.

3. The monitoring device of an injection molding machine according to claim 1,
wherein the amount of change generated in the link member acquired by the acquisition unit is an acceleration generated in the link member.
